(19) United States
(12) Patent Application Publication
(10) Pub. No.: US 2011/0151867 A1
(43) Pub. Date: Jun. 23, 2011

(54) MOBILE TERMINAL, MACRO BASE STATION, AND CELL SELECTION SYSTEM

(75) Inventors: Jun Hirano, Kanagawa (JP); Hidenori Matsuo, Kanagawa (JP)

(73) Assignee: PANASONIC CORPORATION, Osaka (JP)

(21) Appl. No.: 13/060,320

(22) PCT Filed: Jun. 17, 2009
(86) PCT No.: PCT/JP2009/002761

§ 371 Date: Feb. 23, 2011

(30) Foreign Application Priority Data
Sep. 19, 2008 (JP) 2008-241039

(51) Int. Cl. H04W 60/00

(52) U.S. Cl. 455/434

(57) ABSTRACT

A mobile terminal (10) is used in a network comprising a wide area cell and small cells included in the wide area cell. The mobile terminal (10) comprises: a basic communication functionality (12) for receiving offset information used for cell selection and offset correction information for correcting the offset information to increase ease of connection with a micro BS set by a user, both information being broadcasted from a macro base station; a inclination setting section (14) for accepting a setting for a priority home base station with which a user desires to preferentially establish a connection among a plurality of small cells; a offset information correction processing section (18) for correcting the offset information with the offset correction information when the priority home base station is detected; and a cell selection section (24) for performing cell selection based on reception quality with the added offset information. In this way, a user-specific inclination can separately be set for each mobile terminal and the amount of notification of information can be reduced.

The present application claims benefit of Japanese Patent Application No. 2008-241039, filed Sep. 19, 2008, the contents of which are hereby incorporated by reference.

### TECHNICAL FIELD

The present invention relates to a technique for a mobile terminal to select a cell in a network having a first cell and a second cell contained in the first cell.

### BACKGROUND ART

3GPP specifies eNodeB (hereinafter referred to as “eNB”) and Home eNodeB (hereinafter referred to as “HeNB”) as a macro base station that covers a wide area. An HeNB is a micro base station (micro BS) that covers a relatively small area in a cell of the macro base station. An operator of an HeNB can regulate users who may be allowed to access to the HeNB based on an ID (CSGID) associated with the HeNB. An HeNB is a base station configured to allow a user to access the core network managed by a mobile operator even through a network managed by another network operator different from the mobile operator. In addition to HeNBs deployed by mobile operators, it is assumed that HeNBs may be deployed by users themselves of mobile terminals, office managers, or managers of a shopping mall or a public facility.

Similarly to the macro base station, the micro BS can accommodate mobile terminals, which are however deployed in such a way that the deployment reflects an intention of micro BS providers. For example, it is conceivable that a personally owned micro BS would be deployed so as to cover the user's premise as its service cell and multiple micro BSs would be deployed so as to cover the premise of a university if the micro BSs are deployed for a mobile environment in the university.

A micro BS can reflect an intention of the provider and implement access control (CSG) for regulating mobile terminals that may be allowed to connect to the micro BS. In this case, an attempt to connect to the micro BS by a mobile terminal out of CSG members will be rejected. In such a system, the mobile terminal may create and store a white list enumerating micro BSs to which the mobile terminal is allowed to connect. When the mobile terminal detects a micro BS, the mobile terminal looks up the white list and determines whether or not the micro BS is connectable.

For example, the white list can be created as follows: (1) in a mode in which the mobile terminal checks every micro BS to determine whether the micro BS is connectable (i.e. a mode in which a connect procedure is attempted even when the micro BS does not exist in the white list), the mobile terminal makes a request to the network side to add, to the white list, the micro BS that is proved to be connectable; and (2) the mobile terminal negotiates with the network side for identifications (IDs) of the corresponding micro BS or the like, and writes the IDs or the like notified as connectable.

Non-patent documents 1 to 3 describe CSG. Non-patent document 1 describes the definition and operation of a CSG cell (UMTS and LTE), Non-patent document 2 describes required specifications for the CSG cell (LTE), and Non-patent document 3 describes cell selection operation for the CSG cell.

In a system having an eNB or an HeNB as described above, description will now be made to the cell selection for selecting a cell to which the mobile terminal is to handover. The cell selection is basically achieved based on the connection quality of the handover origin cell and that of a candidate for handover destination.

When the connection quality of the handover origin no longer satisfies a certain condition, the mobile terminal performs quality measurement in order to judge availability of other base stations with the intention of connecting to another base station. Selection of a base station of handover destination is governed by the network in the state where data is being transmitted between the mobile terminal side and the network side (active state), and governed by the mobile terminal in the state where data is not transmitted between the mobile terminal side and the network side (idle state).

In either case, connection quality measurements taken by the mobile terminal are compared to each other, and a base station that supposedly has the best quality is selected. At this time, if there is information that should be taken into consideration in addition to the measured quality information as selection criteria for a base station, the network side can notify offset information as a parameter to be added to or subtracted from the measured quality information so as to control a trend for the cell selection.

The offset information may be notified as system information or may separately be notified so as to overwrite the system information in order to set a special value to a specific mobile terminal. The offset information is used, for example, to cancel the difference in measurements taken by the same method when a candidate base station of handover (cell selection) destination is operated in an access technology different from the base station of handover (cell selection) origin. The offset information is also used to direct the mobile terminal to a cell of a frequency band intended by the network side in order to equalize resources in use in each cell of different frequency band.

The offset information can also be set in the white list as information indicative of a level of “ease of connection” with each micro BS.

### CITATION LIST

### Non Patent Literature

Non Patent Literature 1: 3GPP TS22.011 Sections 1 and 8
Non Patent Literature 2: 3GPP TR36.300 Annex F
Non Patent Literature 3: 3 GPP TR36.304 Section 5

### SUMMARY OF INVENTION

### Technical Problem

As described above, since micro BSs are also assumed to be operated by owners who, unlike mobile operators, are closer to users, it is desirable that decision of whether or not a mobile terminal should be connected to a micro BS be made in accordance with an inclination of the users or the owners of the micro BSs. Hereinafter, demands of mobile terminal users on a destination, such as a user's desire to preferentially connect their mobile terminal to the micro BS of the mobile terminal's home (for example, because it provides a benefit in the fee), a user's desire to connect to a publicly provided micro BS, and a user's desire to stay for a certain period in a service area such as a hot spot, are referred to as an inclination of the user. An inclination of the user, however, does not necessarily correspond to a destination determined based on communication parameters or the like on a system.

Cell selection criteria take into consideration factors such as geographical regions, frequency bands, and access technologies. However, the level or trend of how strong a user desires to preferentially use a micro BS varies for each mobile terminal. For example, a different mobile terminal may lead to the opposite result in terms of a trend of choice of a micro BS preferentially used. The choice of a micro BS preferentially used may also vary over time depending on changes in mobile terminal usage by a user, and an inclination of the user may be opposite in different times even though a priority micro BS has been set.

In order to set, for each mobile terminal, a level of “ease of connection” with each micro BS, it is conceivable to notify offset information arranged for each mobile terminal and for each micro BS. In this case, a mobile terminal makes a request to change offset information directed to the corresponding micro BS depending on changes in inclination settings of the user. In response to the request from the mobile terminal, the network side advertises, via a macro base station, a list of offset values that each of the mobile terminals uses in cell selection of the respective micro BSs. When the mobile terminal discovers a micro BS, the mobile terminal uses the received list of offset values to select a cell.

Such a method, however, has a problem of a flood of system information. For example, assuming that n mobile terminals and m micro BSs are present in a cell provided by a single macro base station, the system information, which must be advertised, amounts to n×m pieces of offset information and information of listed IDs of mobile terminals and micro BSs that should use the offset information. However, the size of system information is generally limited and it is undesirable to use such a structure that leads to a flood of system information.

It is also conceivable to use a white list as described above. When a change is made to inclination settings of the user, the mobile terminal makes a request to change the organization of the white list and notifies the network side of a desirable level of change how much priority should be given to which micro BS. Based on the notification, the network side changes the priority added to the white list. The network side updates, via a macro base station, the offset information that each of the mobile terminals uses in cell selection of the respective micro BSs. When the mobile terminal discovers a micro BS, the mobile terminal uses the latest offset indicated in the white list to select a cell.

However, the usage of the white list is mainly intended to manage static information on whether a micro BS may be considered as a proper destination, and is less suitable to handle frequently updated data. Since the white list is automatically updated in a long cycle, it is necessary to perform a procedure that includes a plurality of signaling if the white list is to be intentionally updated. In such a situation where a priority micro BS must be frequently updated since inclination settings change over time depending on changes in mobile terminal usage by a user, the change in the inclination settings cannot be caught up with unless the white list is frequently updated. This is undesirable for the white list usage. There is also a problem of a flood of system information.

Therefore, in view of the above situation, an object of the present invention is to propose a cell selection control method in which a user-specific inclination can separately be set for each mobile terminal and the amount of notification of information is reduced.

### Solution to Problem

A mobile terminal according to the present invention is a mobile terminal used in a network comprising a macro base station and a plurality of home base stations, the mobile terminal comprising: a reception quality measurement section for measuring reception quality of a signal transmitted from the macro base station and the home base station; an offset information receiving section for receiving offset information used for cell selection from the macro base station; an offset correction information receiving section for receiving offset correction information for correcting the offset information, the offset correction information being broadcasted from the macro base station; a priority base station information storing section for storing information on at least one priority home base station among the plurality of home base stations, the priority home base station being preferentially selected to establish a connection; an offset information correction section for correcting the offset information with the offset correction information when the priority home base station is detected; and a cell selection section for adding offset information received at the offset information receiving section or offset information corrected at the offset information correction section to the reception quality, and performing cell selection based on the reception quality with the added offset information.

With this configuration, a priority home base station with which a user desires to preferentially establish a connection is more likely to be selected, and since a base station transmits offset correction information, it is possible to adjust the level of how easily the priority home base station is selected. Since the macro base station may simply advertise common information to all mobile terminals, the amount of notified information can be reduced.

A macro base station according to the present invention is a macro base station comprising a plurality of home base stations in a cell under control, the macro base station comprising: an offset information transmitting section for transmitting offset information used for cell selection to a mobile terminal; and an offset correction information transmitting section for transmitting offset correction information for correcting the offset information to the mobile terminal by broadcast.

With this configuration, a priority home base station with which a user desires to preferentially establish a connection is more likely to be selected, and since the macro base station transmits offset correction information, it is possible to adjust the level of how easily the home base station is selected. Since the macro base station may simply advertise common information to all mobile terminals, the amount of notified information can be reduced.

A cell selection system according to the present invention is a system for controlling cell selection performed by a mobile terminal in a network comprising a macro base station and a plurality of home base stations, wherein the macro base station comprises: an offset information transmitting section for transmitting offset information used for cell selection to a mobile terminal; and an offset correction information transmitting section for transmitting offset correction information for correcting the offset information to the mobile terminal by broadcast, the mobile terminal comprises: a reception quality measurement section for measuring reception quality of a signal transmitted from the macro base station and the home base station; an offset information receiving section for receiving the offset information from the macro base station; an offset correction information receiving section for receiving the offset correction information from the macro base station; a priority base station information storing section for storing information on at least one priority home base station among the plurality of home base stations, the priority home base station being preferentially selected to establish a connection; an offset information correction section for correcting the offset information with the offset correction information when the priority home base station is detected; and a cell selection section for adding offset information received at the offset information receiving section or offset information corrected at the offset information correction section to the reception quality, and performing cell selection based on the reception quality with the added offset information.

A cell selection method according to the present invention is a cell selection method for a mobile terminal used in a network comprising a macro base station and a plurality of home base stations, the method comprising: receiving offset information used for cell selection from the macro base station; receiving offset correction information for correcting the offset information, the offset correction information being broadcasted from the macro base station; storing information on at least one priority home base station among the plurality of home base stations in a priority base station information storing section, the priority home base station being preferentially selected to establish a connection; measuring reception quality of a signal transmitted from the macro base station and the home base station; correcting the offset information with the offset correction information when the priority home base station is detected; and adding offset information received from the macro base station or offset information corrected with the offset correction information to the reception quality, and performing cell selection based on the reception quality with the added offset information.

A cell selection control method according to the present invention is a method for controlling cell selection of a mobile terminal by a macro base station comprising a plurality of home base stations in a cell under control, the method comprising: transmitting offset information used for cell selection to the mobile terminal; and transmitting offset correction information for correcting the offset information to the mobile terminal by broadcast.

### Advantageous Effects of Invention

According to the present invention, a priority home base station stored in the priority base station information storing section is more likely to be selected. Since a base station transmits offset correction information, it is advantageously possible to adjust the level of how easily the priority home base station is selected, and the amount of notified information can be reduced.

As described herein, there are other embodiments of the invention. Therefore, the disclosure of the invention is intended to provide a part of the invention and is not intended to limit the scope of the invention as described and claimed herein.

### BRIEF DESCRIPTION OF DRAWINGS

FIG. 1 is a diagram showing a configuration of a mobile terminal according to a first embodiment.

FIG. 2 is a diagram showing a configuration of a macro base station according to the first embodiment.

FIG. 3 is a diagram showing a configuration of a network in which the mobile terminal and the macro base station according to the first embodiment are implemented.

FIG. 4 is a diagram showing an example of data retained in an offset correction information retaining section according to the first embodiment.

FIG. 5 is a diagram showing an example of system information transmitted from the macro base station according to the first embodiment.

FIG. 6 is a diagram showing operation of the mobile terminal according to the first embodiment.

FIG. 7 is a diagram showing a configuration of a macro base station according to a second embodiment.

FIG. 8 is a diagram showing an example of system information transmitted from the macro base station according to the second embodiment.

FIG. 9 is a diagram showing a configuration of a mobile terminal according to the second embodiment.

FIG. 10 is a diagram showing operation of the mobile terminal according to the second embodiment.

FIG. 11 is a diagram showing an example of data retained in an offset correction information retaining section according to a third embodiment.

### DESCRIPTION OF EMBODIMENTS

The present invention will now be described in detail. Embodiments described herein are exemplary only and various modifications can be made to the present invention. Therefore, a specific configuration and functionality disclosed herein do not limit the scope of the claims.

A base station, a mobile terminal, and a cell selection method according to embodiments of the invention will now be described with reference to the drawings. In embodiments described herein, description is made to an example in which a micro BS is a 3GPP LTE system-enabled Home eNB. The present invention, however, can be applied to a 3GPP UMTS system-enabled Home eNB In this case, the mobile terminal is necessarily subjected to changes according to the difference in system conditions, such as cell selection performed in other states than the idle state. Such changes, however, are obvious design changes to those skilled in the art.

### First Embodiment

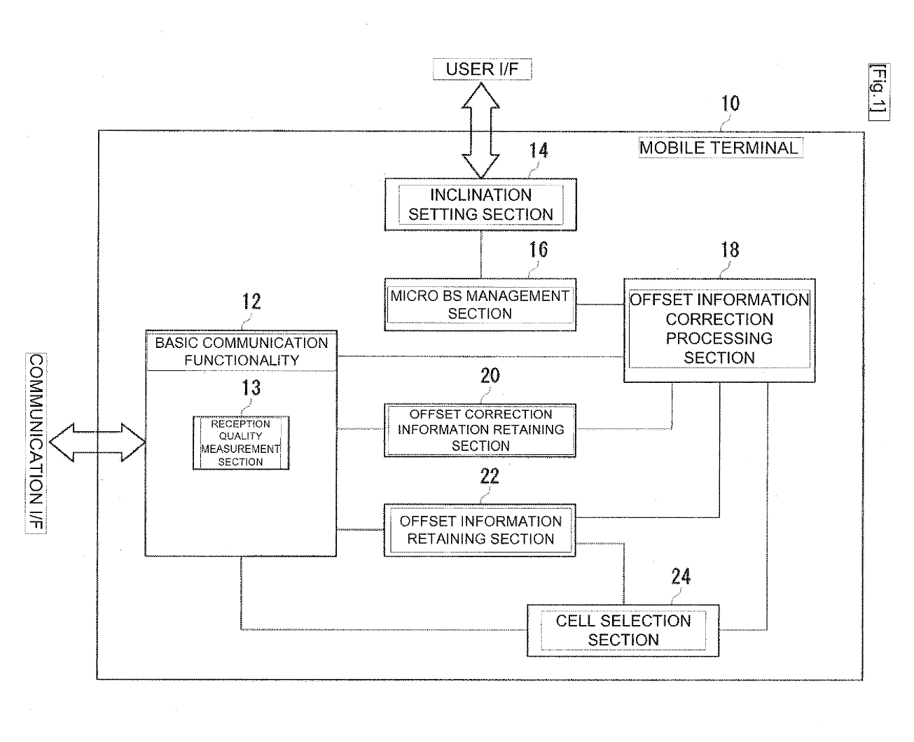

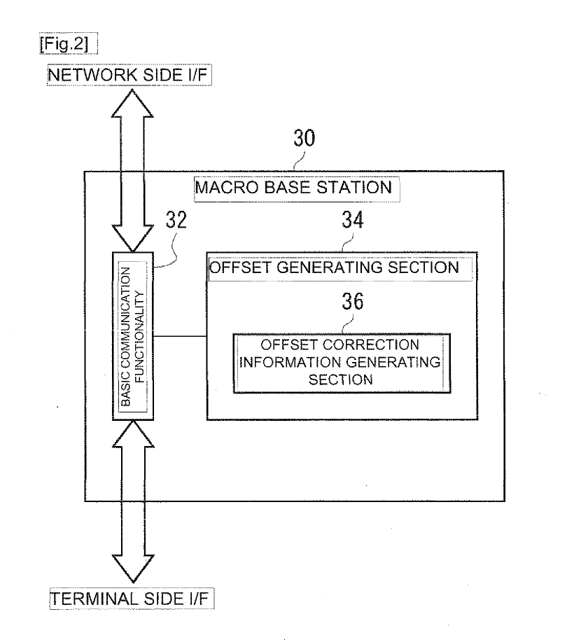

FIG. 1 is a diagram showing a configuration of a mobile terminal 10 according to a first embodiment, and FIG. 2 is a diagram showing a configuration of a macro base station 30. Before the detail description of the mobile terminal 10 and the macro base station 30 with reference to FIGS. 1 and 2, a network in which the mobile terminal 10 and the macro base station 30 are implemented will be described.

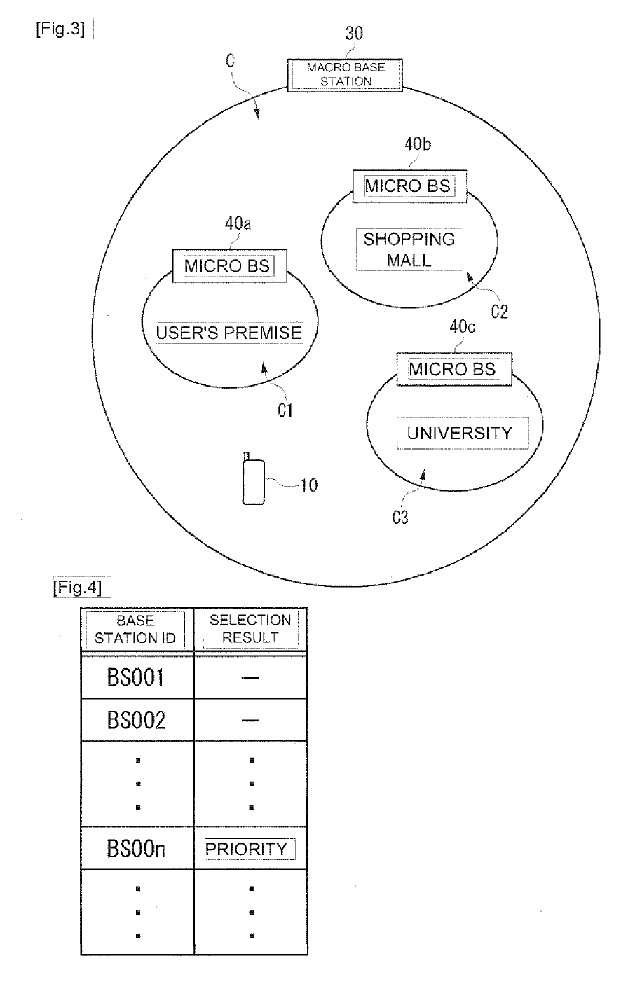

FIG. 3 is a diagram showing a configuration of a network in which the mobile terminal 10 and the macro base station 30 according to the first embodiment are implemented. In a wide area cell C provided by the macro base station 30, multiple micro BSs 40a to 40c are deployed. Hereinafter, the micro BSs 40a to 40c are collectively referred to as micro BS 40, if appropriate. The micro BSs 40a to 40c provide their own cells C1 to C3. For example, the macro base station 30 is, but not limited to, an eNB specified by 3GPP and the micro BS is an HeNB specified by 3GPP.

The micro BS 40 may be operated by a provider different from a provider of the macro base station 30, or may be operated by the same provider. In an example shown in FIG. 3, the micro BS 40a is deployed in a user's premise, the micro BS 40b in a shopping mall, and the micro BS 40c in a university.

The mobile terminal 10 is capable of communicating with the macro base station 30 and with the micro BS 40. If the micro BS 40 does not permit communication with the mobile terminal 10, the communication cannot be established. For example, in an example shown in FIG. 3, the micro BS 40 deployed in the university can reject communication with the mobile terminal 10 of any other person than the staff of the university.

When the mobile terminal 10 enters the coverage of the micro BS 40, the mobile terminal 10 can communicate with either the macro base station 30 or the micro BS 40, whichever has a better connection quality. Selecting a cell in this way among a plurality of cells based on the connection quality is referred to as cell selection.

### [Mobile Terminal]

A configuration of the mobile terminal 10 will now be described with reference to FIG. 1. The mobile terminal 10 comprises a basic communication functionality 12, an inclination setting section 14, a micro BS management section 16, an offset information correction processing section 18, an offset correction information retaining section 20, an offset information retaining section 22, and a cell selection section 24. The basic communication functionality 12 comprises a reception quality measurement section 13 for measuring the reception quality of a signal from the macro base station and the home base station. Although not shown in FIG. 1, similarly to a conventional mobile terminal, the mobile terminal 10 also comprises a data transmitting/receiving section, an inter-base station handover functionality section, and the like. Each component of the mobile terminal 10 will now be described.

The inclination setting section 14 has a function to set an inclination of a user to indicate which micro BS 40 among the plurality of micro BSs 40 the user desires to preferentially establish a connection. The inclination of the user may be received from a user input or may be estimated by application software or the like. The inclination setting section 14 notifies the micro BS management section 16 of data of a micro BS 40 that is preferentially connected. The micro BS management section 16 serves as the “priority base station information storing section” according to the invention.

The micro BS management section 16 stores and manages a list of IDs of micro BSs 40 to which the mobile terminal 10 can connect. The list may be organized by extending functional blocks of a conventional mobile terminal that manage a white list notified from a network side. In this way, information on micro BSs 40 can relatively easily be managed.

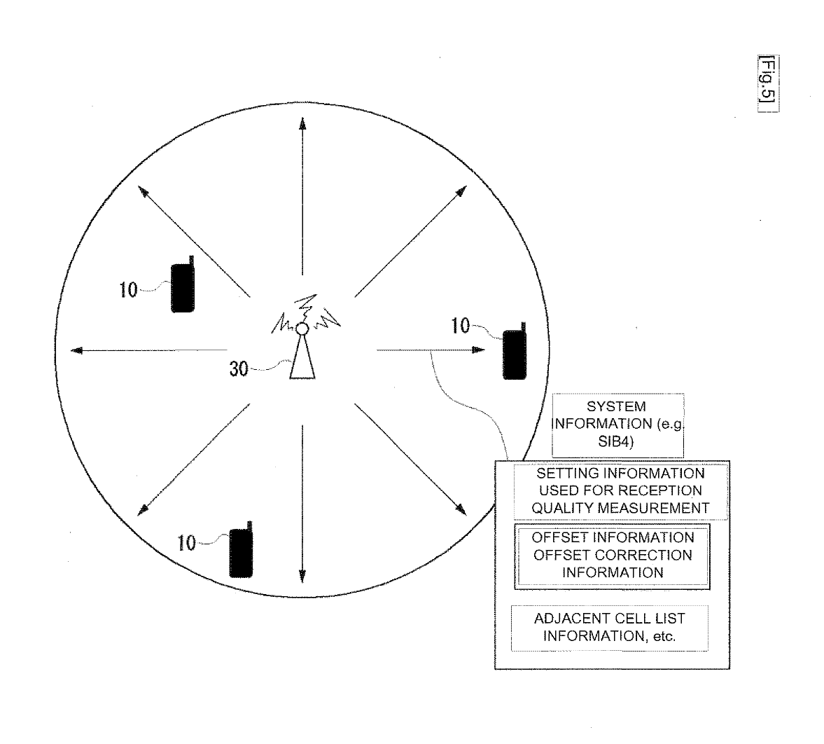

FIG. 4 is a diagram showing an example of a list managed by the micro BS management section 16 according to the embodiment. As shown in FIG. 4, entries notified from the inclination setting section 14, which are indicative of information on a selection of priority micro BSs 40 and a selection of non-priority micro BSs 40, are added to the list of IDs of micro BSs 40 in a white list. Here, “non-priority” refers to a base station to which a priority is not set. In this way, the IDs of micro BSs 40 in the white list and selection results of priority/non-priority of the micro BSs 40 are managed in association with each other. If a micro BS 40 to which a connection priority is set by a user is not included in the white list, a process may be performed either to discard the set information of the micro BS 40 or to add the information of the micro BS 40 to the white list.

The offset information retaining section 22 retains offset information used for cell selection. The offset information is transmitted from the macro base station 30. The offset information retaining section 22 may be configured by adding a retaining area for the micro BS 40 to an information retaining area of a conventional mobile terminal 10. The contents of the offset information retaining section 22 are updated at times, such as when system information including offset information is received and when offset information is received again. The offset information retaining section 22 may be configured to discard the contents under certain conditions, such as expiration of a certain time period and a change made in the macro base station 30.

The offset correction information retaining section 20 retains offset correction information included in the system information. The offset correction information retaining section 20 is updated at tunes, such as when the mobile terminal 10 receives offset correction information again. The offset correction information retaining section 20 may be configured to discard the contents under certain conditions, such as expiration of a certain time period and a change in the macro base station 30.

The offset information correction processing section 18 has a function to correct offset information used for making decision on cell selection when a candidate micro BS 40 for cell selection to which a connection priority is set. When the mobile terminal 10 starts to measure communication quality in order to perform cell selection to connect to a micro BS 40, the offset information correction processing section 18 looks up retained data to check whether a connection priority is set to the target micro BS 40. If the connection priority is set, the offset information correction processing section 18 corrects offset information read from the offset information retaining section 22 with offset correction information read from the offset correction information retaining section 20. The offset information correction processing section 18 inputs the corrected offset information to the cell selection section 24 and controls the cell selection section 24 to use the corrected offset information to perform cell selection. If the connection priority is not set to the target micro BS 40, the offset information correction processing section 18 controls the cell selection section 24 to use offset information retained in the offset information retaining section 22 to perform cell selection.

The ID of a micro BS 40 is desirably unique among micro BSs 40 that can be detected by the mobile terminal 10. To this end, for example, the mobile terminal 10 is arranged to receive the ID of a micro BS 40 included in system information notified from the micro BS 40 to uniquely identify the micro BS 40.

To uniquely identify the micro BS 40, information that uniquely identifies the micro BS 40 may also be received in advance at the beginning of quality measurement (at the beginning of a cell selection procedure) by, for example, checking system information of the micro BS 40 to be measured (a target for cell selection). A plurality of ID structures and other information may also be combined to uniquely or accurately identify the micro BS 40. For example, an ID capable of coexisting with an ID that uniquely identifies the micro BS 40 may be associated with location information (which may be an ID of a macro base station) to accurately derive the ID that uniquely identifies the micro BS 40 from the location information even when only the ID capable of coexisting with other IDs is received.

The cell selection section 24 has a function to perform cell selection based on the measurement result of the reception quality of a signal from the macro base station 30, a micro BS 40, or the like. For a micro BS 40 designated by the offset information correction processing section 18, the cell selection section 24 uses the corrected offset information to perform cell selection.

### [Macro Base Station]

A configuration of the macro base station 30 according to the embodiment will now be described with reference to FIG. 2. The macro base station 30 comprises a basic communication functionality 32 and an offset generating section 34. Although not shown in FIG. 2, similarly to a conventional macro base station 30, the macro base station 30 also comprises a data transmitting/receiving section, a setting information (including offset information) notification functionality, a white list notification functionality, a handover determination functionality, and the like.

The offset generating section 34 has a function to generate offset information used for cell selection to connect to a micro BS 40, and to notify it to the mobile terminal 10. Here, “offset information” refers to offset information directed to a micro BS 40 to which a connection priority is not set by a user. The offset information is a value set by each macro base station 30, which controls the offset information such that it has an appropriate value for a cell C provided by the macro base station 30. The offset information is applicable to all mobile terminals 10 in the cell, and contains common offset information for all micro BSs 40 in the cell. Therefore, the offset information does not require an ID of a mobile terminal 10 or an ID of a micro BS 40, and can be advertised in a relatively small amount of data.

The offset generating section 34 comprises an offset correction information generating section 36. The offset correction information generating section 36 has a function to generate offset correction information and notify it to the mobile terminal 10. The offset correction information is information for correcting offset information such that a micro BS 40 to which a connection priority is set is more likely to be selected, and indicates an allowable amount of correction. The offset correction information is also a value set by each macro base station 30, which controls the offset correction information such that it has an appropriate value for a cell provided by the macro base station 30. The offset correction information is applicable to all mobile terminals 10 in the cell, and contains offset correction information for any micro BS 40 selected by the mobile terminal 10. Therefore, the offset correction information does not require an ID of a mobile terminal 10 or an ID of a micro BS 40, and can be advertised in a relatively small amount of data.

The macro base station 30 broadcasts the offset information and the offset correction information to the mobile terminals 10 present in the cell all at once.

The operation of the mobile terminal 10 and the macro base station 30 according to the embodiment will now be described. In the description below, description will now be made to an example of cell selection performed when a cell of a micro BS 40 is detected by a mobile terminal 10 present in the cell of the macro base station 30.

FIG. 5 is a diagram showing an example of system information transmitted from the macro base station 30. The macro base station 30 broadcasts system information that includes offset information and offset correction information. In the example shown in FIG. 5, the offset correction information is advertised within setting information used for reception quality measurement as additional information to offset information. As the system information, SIB4 (System Information Block 4) can be used, for example. The offset correction information may separately be advertised within setting information used for reception quality measurement contained in system information from the macro base station 30, instead of being as additional information to offset information.

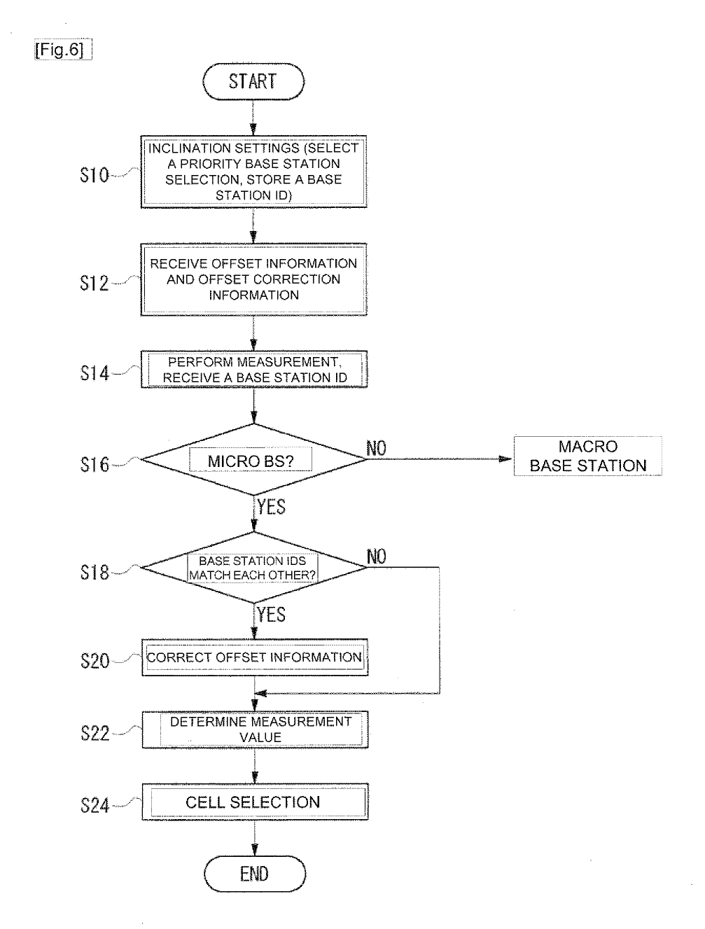

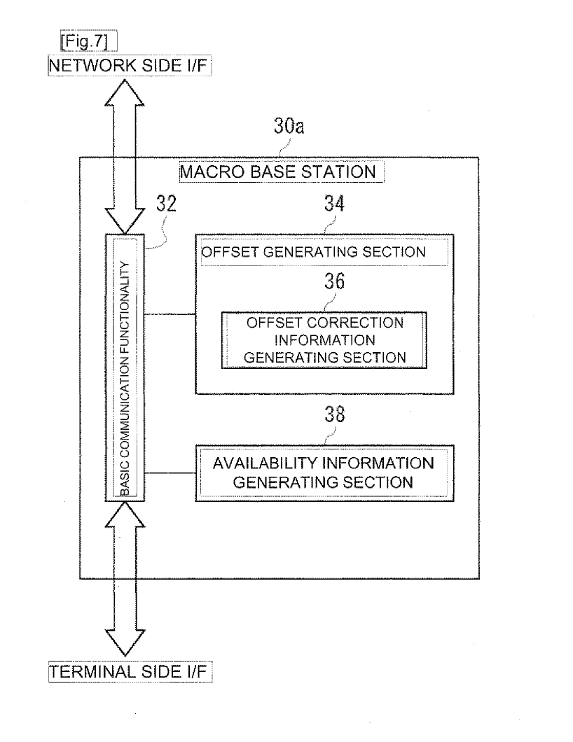

FIG. 6 is a diagram showing operation of the mobile terminal 10. The mobile terminal 10 first accepts an inclination setting from the user (S10). Specifically, the mobile terminal 10 accepts a user setting for a micro BS 40 to which the user desires to preferentially connect, and saves the ID of the set micro BS 40. That is, the mobile terminal saves, in a list of IDs of Micro BSs 40, information indicating that the mobile terminal preferentially connects to the micro BS 40 of interest, as shown in FIG. 4. In the embodiment, although an example of setting a micro BS 40 to which the user desires to preferentially connect is described, a connection priority may otherwise be saved in the list of IDs of micro BSs 40. For example, a home base station located at a user's home may be set to have a connection priority without the user input. If the mobile terminal has user attributes (such as a generation) in association with a micro BS 40, micro BS 40 attributes and the user attributes of the mobile terminal 10 may be compared, and a connection priority may be set to a micro BS 40 that matches the user attributes.

The mobile terminal 10 receives offset information and offset correction information transmitted from the macro base station 30 (S12), and retains the received offset information and the offset correction information in the offset information retaining section 22 and the offset correction information retaining section 20, respectively.

The mobile terminal 10 measures reception quality of a nearby base station, and receives a base station ID of the measured base station from system information (S14).

From the received system information, the mobile terminal 10 determines whether or not the base station that has transmitted the system information is a micro BS 40 (S16). If the base station of the adjacent cell is not the micro BS 40 (NO in S16), it implies cell selection from a macro base station 30 to another macro base station 30, and the mobile terminal 10 operates according to a conventional cell selection procedure.

If the base station that has transmitted the system information is a micro BS 40 (YES in S16), the mobile terminal 10 determines whether or not the ID of the base station that has transmitted the system information matches an ID of a base station to which a connection priority is set based on data managed by the micro BS management section 16 (S18). As a result, if the IDs of the base stations match (YES in S18), the mobile terminal 10 corrects offset information retained in the offset information retaining section 22 with offset correction information retained in the offset correction information retaining section 20 (S20). If the IDs of the base stations do not match (NO in S18), offset information is not corrected and the system proceeds to the next process.

The mobile terminal 10 adds offset information read from the offset information retaining section 22 or offset information corrected by the offset information correction processing section 18 to reception quality of each of candidate cells for cell selection to determine a measurement value (S22). The mobile terminal 10 performs cell selection based on the offset-added measurement value (S24). The mobile terminal 10 and the macro base station 30 according to the first embodiment have been described above. The reception quality to be measured may be the received power of a known signal (e.g. reference signal or pilot signal) or the like.

The mobile terminal 10 according to the embodiment uses offset correction information to correct offset information during cell selection for a micro BS 40 to which a connection priority is set by a user. In this way, the mobile terminal 10 can perform cell selection based on a priority to a specific micro BS 40 set based on an inclination of a user, without negotiating with a macro base station 30 how strong the user desires to give priority to the specific micro BS 40.

The macro base station 30 according to the embodiment transmits offset correction information for correcting offset information, and therefore, can control the level of priority allowed for the mobile terminal 10 to set as basic setting criteria.

As described above, since the offset information and the offset correction information are common to all mobile terminals 10 and all micro B Ss 40 and an ID of the mobile terminal 10 or an ID of the micro BS 40 is not required, the amount of system information can be reduced.

In the first embodiment as described above, an upper limit may be placed on the number of micro BSs 40 in which the inclination setting section 14 of the mobile terminal 10 can accept connection priority settings. The upper limit may be preset and stored in the mobile terminal 10. Alternatively, the macro base station 30 may notify information on the upper limit to the mobile terminal 10 during communication, and the mobile terminal 10 may receive and store the information notified from the macro base station 30. The notification from the macro base station 30, if used, may depend on situations. The system information may be used for the notification or the notification may be sent separately to each mobile terminal.

In a case where the upper limit is notified from the macro base station 30, it is possible, for example, to prepare an upper limit of the number of micro BSs 40 in which offset correction information can be applied to offset information under certain conditions; for example, in a certain duration and within an area serviced by the same macro base station 30, and to set the upper limit to the mobile terminal 10 in advance or when the mobile terminal 10 needs to be controlled. In this way, in a cell provided by the macro base station 30, it is possible to control a mobile terminal 10 that uses higher transmitted power for transmission (i.e. an interference factor in the cell) than the normal power.

### Second Embodiment

A mobile terminal 10a and a macro base station 30a according to a second embodiment of the invention will now be described. In the second embodiment, the macro base station 30a controls timing when the macro base station 30a allows cell selection that is performed based on a connection priority setting.

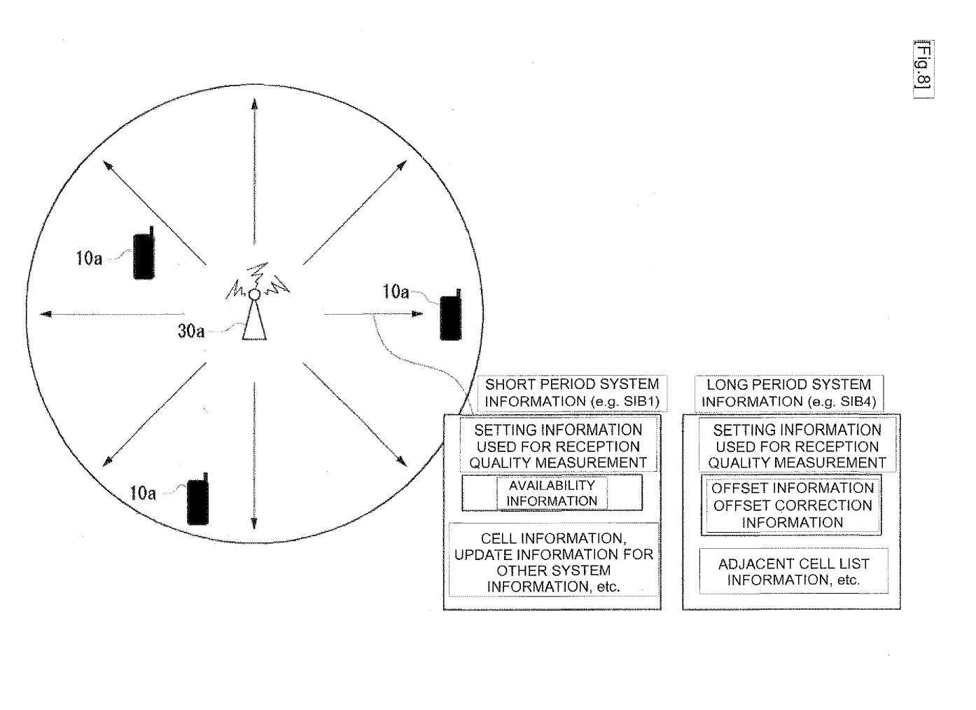

FIG. 7 is a diagram showing a configuration of a mobile terminal 30a according to a second embodiment. The macro base station 30a according to the second embodiment has a availability information generating section 38 in addition to the configuration of the macro base station 30 according to the first embodiment.

The availability information generating section 38 has a function to determine whether the mobile terminal 10a should be allowed to correct offset information with offset correction information for cell selection to connect to a micro BS 40 depending on operational conditions of the cell at the time or upon controlled from the network side, and a function to generate availability information for notifying an available or unavailable state based on the determination and notify it to the mobile terminal 10a.

The availability information is flag information consisting of one to several bits, and the availability information is used to indicate availability of offset correction information at times. For example, the availability information may be set so as to indicate that offset correction information is available in light of the circumstance where interference caused by the mobile terminal 10a transmitting with increased transmitted power is in an allowable range, or may be set so as to indicate that offset correction information is available in light of the fact that micro BSs 40 in the cell provided by the current macro base station 30a are operated at different frequencies from the macro base station 30a and therefore effects of interference may be less significant. Since it is conceivable that such a situation is dependent on time or environment, the availability information may desirably be set for each macro base station 30a independently at a different timing. The availability information generating section 38 constantly advertises availability information in a cycle depending on the frequency of control from the network side or as required by the situation.

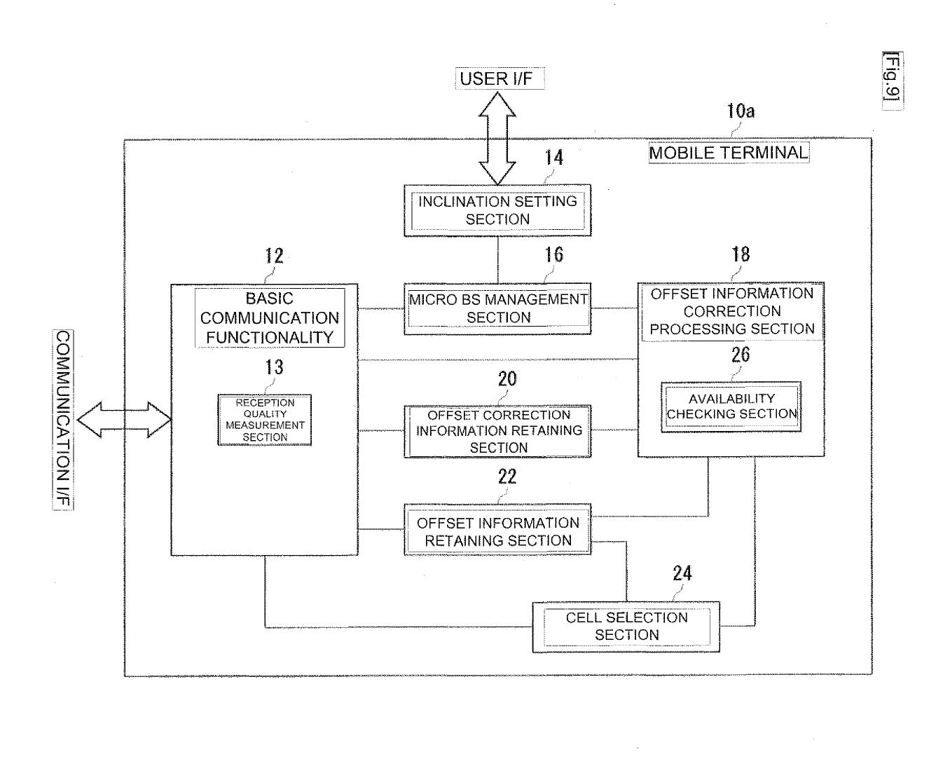

FIG. 8 is a diagram showing an example of system information transmitted from the macro base station 30a. The macro base station 30a according to the second embodiment puts availability information into setting information used for reception quality measurement within short period system information and transmits it. As the short period system information, SIB1 can be used, for example.

FIG. 9 is a diagram showing a configuration of a mobile terminal 10a according to the second embodiment. The basic configuration of the mobile terminal 10a according to the second embodiment is similar to the mobile terminal 10 according to the first embodiment. In the second embodiment, however, the offset information correction processing section 18 comprises a availability checking section 26.

The availability checking section 26 has a function to check the state of availability information contained in system information to determine whether offset correction information to be used may be available at the time when the offset information correction processing section 18 looks up the micro BS management section 16 to check whether the micro BS 40 is selected for priority/non-priority correction. Consequently, if offset correction information is available, cell selection is performed by using offset correction information corrected at the offset information correction processing section 18, and if not, cell selection is performed by using offset information retained in the offset information retaining section 22.

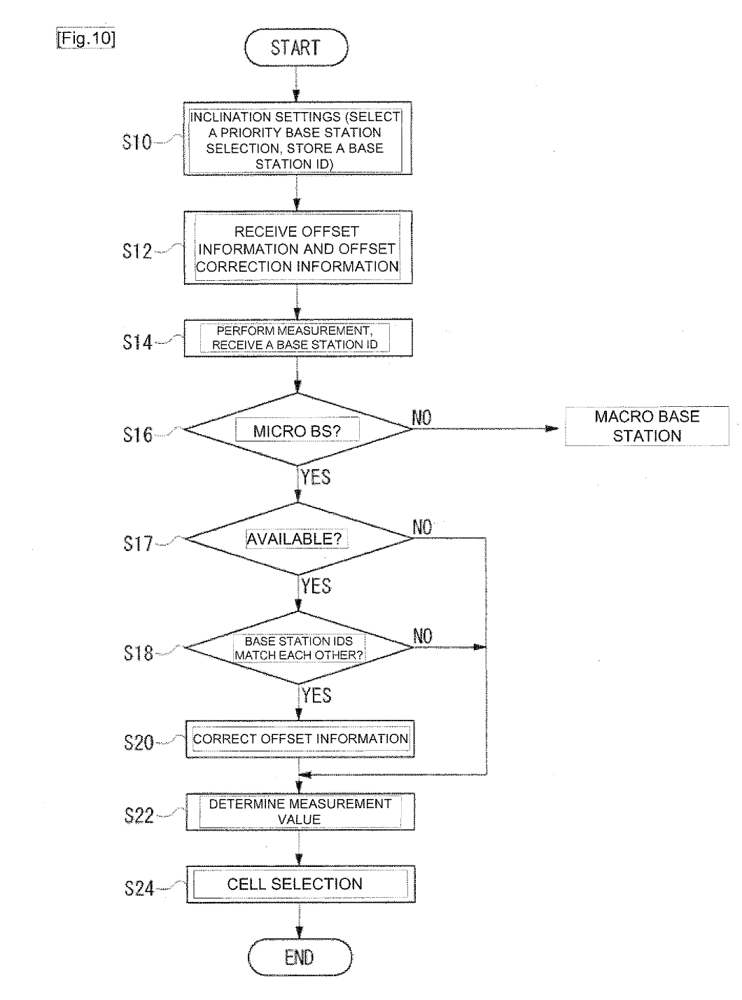

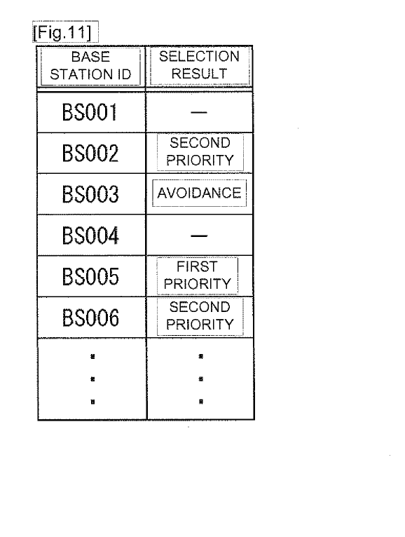

FIG. 10 is a diagram showing operation of the mobile terminal 10a according to the second embodiment. The basic operation of the mobile terminal 10a according to the second embodiment is similar to that of the mobile terminal 10 according to the first embodiment; however, a availability determination process is added to determine whether or not offset correction information may be used (S17). In the availability determination process, the mobile terminal 10a obtains availability information from short period system information, and it is determined whether or not use of offset correction information is allowed based on the obtained availability information. In a case where offset correction information is allowed to use, both offset information and offset correction information may be obtained for update as necessary.

In an example shown in FIG. 10, availability of offset correction information is determined before determination of a base station ID. However, the availability determination may be performed after the determination of a base station ID (S18).

The macro base station 30a according to the second embodiment notifies, by availability information, that a preferential connection based on an inclination of the user may be permitted or not, and the mobile terminal 10a determines whether or not the preferential connection should be performed base on the availability information. In this way, a provider (for example, a mobile operator) of the macro base station 30a can control permission in terms of whether to permit or not permit a preferential connection depending on the circumstance at the time of cell selection by the mobile terminal 10a.

For example, preferentially connecting the mobile terminal 10a to the micro BS 40 instead of the macro base station 30a implies that, in communication between the mobile terminal 10a and the micro BS 40, the connection may be established, that is, the mobile terminal 10a may transmits data even under the condition of lower communication quality, such as when they suffer more radio interference and when the mobile terminal 10a is located relatively far away from the micro BS 40, compared to the normal case (i.e. the case of no preferential connection). Therefore, in order to achieve sufficient communication quality, the mobile terminal 10a may be required to increase the transmitted power for communication. Since cells provided by micro BSs 40 are often contained in a cell provided by the macro base station 30a, a mobile terminal 10a that increases transmitted power to transmit data for connecting to a micro BS 40 would add to interference and noise sources for other mobile terminals 10a that connect to other macro base stations 30a located nearby (and are not attempting to connect to the micro BS 40). This leads to a decreased performance of the system in the cell provided by the macro base station 30a, and therefore, it is desirable to provide controllability depending on situations based on an operational decision made by the network side.

The availability information can be used to provide controllability, for example, to permit a preferential connection in a residential area in the night time and to prioritize interference control in the day time. The availability control depending on time zones in the macro base station 30a that covers a residential area may provide precise controllability depending on user activities (such as the number of users staying outdoors). When users are active, the macro base station 30a may generate and notify availability information intended to suppress the use of offset correction information so as to ensure that effects on mobile terminals 10a in connection with the cell C provided by the macro base station 30a is less significant, and when users are calm, the macro base station 30a may generate and notify availability information intended to permit the use of offset correction information so as to increase ease of connection to a micro BS 40 at home. At some time of the day such as midnight, users are inactive and few active connections are established. Therefore, availability information may be controlled to connect mobile terminals 10a to the macro base station 30a so as to place each of the micro BSs 40 in a power saving state or a standby state.

### Third Embodiment

A mobile terminal 10 and a macro base station 30 according to a third embodiment of the invention will now be described. The basic configuration of the mobile terminal 10 and the macro base station 30 according to the third embodiment is similar to that of the mobile terminal 10 and the macro base station 30 according to the first embodiment. In the third embodiment, however, there are several types of offset correction information. Each of these multiple types of offset correction information is correction information for realizing a different level of ease of connection depending on a priority.

FIG. 11 is a diagram showing an example of a list of micro BSs 40 managed by the micro BS management section 16 on the mobile terminal 10 according to the third embodiment. In FIG. 11, IDs of micro BSs 40 are shown associated with three different priorities: “first priority”, “second priority” and “-”. To the micro BS 40 designated as “first priority”, offset correction information for the most connectable micro BS is applied and to the micro BSs 40 designated as “second priority”, offset correction information for the second best connectable micro BS is applied. No offset correction information is applied to the micro BSs 40 shown with “-”.

The macro base station 30 notifies to a mobile terminal 10 the respective offset correction information applied to the “first priority” micro BS 40 and “second priority” micro BSs 40 in addition to offset information. The mobile terminal 10 assigns one of the three levels of ease of connection, including the case where the advertised offset information is used as it is, to a micro BS 40 selected based on inclination settings. Although the example uses three levels of ease of connection in the embodiment, any number of levels of ease of connection may be used.

In the third embodiment, a micro BS 40 that is less connectable, as indicated by “avoidance” in FIG. 11. In other words, there is specified a micro BS 40 that has a non-priority setting or has a low priority setting. In the embodiment, offset information is corrected to ensure that the micro BS 40 designated as “avoidance” is less connectable. The offset correction information in this case is information for inducing a shift to the opposite direction to offset correction information intended for increasing ease of connection with a micro BS 40.

The mobile terminals 10 and the macro base station 30 according to the third embodiment allow stepwise setting for ease of connection with micro BSs 40, and therefore, provide precise controllability depending on providers or attributes of the micro BSs 40.

For example, the third embodiment is useful in cases where multiple micro BSs 40 are deployed in a wide area such as in a campus of a university and a multi-family residential area and a specific micro BS 40 serves as a base for mobile terminals 10. In the case of a university campus, offset information to which second-priority offset correction information is applied can be used to reflect the difference (inclination settings) of micro BSs 40 in the cell C provided by the macro base station 30 from other micro BSs 40 located outside the university campus. In the mobile terminals 10 for particular students, offset information to which first-priority offset correction information is applied can be used to reflect the difference (inclination settings) between micro BSs 40 in the university campus such that the students can preferentially connect their mobile terminals to a micro BS 40 of their departmental building. In such an application of offset correction information, it is also advantageous that changes in inclination settings of a user can immediately be accommodated by, for example, changing a micro BS 40 of their common building to first priority within a class time zone in the common building.

The ability of thus reflecting inclination settings depending on time zones, locations, and users is also useful for installers of micro BSs 40. For example, normal offset correction information advertised from the macro base station 30 may be used as second-priority offset correction information, and subsequently, upon connection of a mobile terminal 10 to a micro BS 40 in the university campus, the micro BS 40 may (newly or additionally) notify information corresponding to first-priority offset correction information. In this way, the installer may be provided with precise controllability of micro BSs 40 in the university campus. As long as effects on macro base station 30 are managed, the ability for a mobile operator to provide setting means for setting a difference of each micro BS 40 improves convenience for the installer of the micro BSs 40. In addition, there is an advantage of the macro base station 30 (mobile operator) side in that when a micro BS 40 in the university campus notifies (additional) offset correction information, total resource consumption can be reduced compared to that consumed when the macro base station 30 notifies offset correction information required to perform precise control.

Furthermore, setting “avoidance” for ensuring that the micro BS 40 is less connectable provides controllability depending on user needs. For example, it is conceivable, as user inclination settings, to use offset information to which offset correction information intended for increasing ease of connection with a micro BS 40 is applied when the user is moving toward a specific destination such as an office, and to use offset information to which “avoidance” offset correction information is applied in order to make micro BSs 40 less connectable, such as those located at shops providing hot spot services along the route, for ensuring that the mobile terminal 10 is prevented from connecting to such micro BSs 40 whenever they are detected. It is possible to release the “avoidance” offset correction information set as inclination settings for ensuring that micro BSs 40 such as those located at shops providing hot spot services are less connectable and to return to the normal state at such a time as the user comes home.

Such a method is also useful to avoid a situation such as when the user is traveling in a car or train and a connection may be established with a micro BS 40 that is not intended by the user (i.e. simply on the way) through destination determination performed by the network side using only traveling speed or the like when the car or train is temporarily stopped.

In this case, availability information may be handled differently from the case when only offset correction information intended for increasing ease of connection is used. For example, when availability information is used for the purpose of interference control, applying offset correction information intended for ensuring that micro BSs 40 are less connectable to offset information will not lead to the increase of interference. In this case, similarly to the case of multilevel availability information, it is desirable to notify availability information in a separate manner. In an alternative control method, the meaning of “available” and “unavailable” may be redefined to “offset information may be corrected to a connectable state” and “offset information may be corrected to a less connectable state”, respectively.

Although the third embodiment has been described, an upper limit may be placed on the number of micro BSs 40 to which offset correction information may be applied, similarly to the first embodiment. In this case, the upper limit may be determined for each priority.

The availability information configuration of the second embodiment as described above may also be applied to the third embodiment. In this case, among a plurality of different pieces of offset correction information, it is possible to control availability depending on priorities by defining at most which offset correction information is allowed to use such that the subsequent pieces of offset correction information are not allowed to use.

In a case where multiple pieces of offset correction information are notified, there are different effects on the macro base station 30 when a mobile terminal 10 needs to increase its transmitted power for communication. Setting a micro BS 40 to increase ease of connection implies that a mobile terminal 10 tries to connect to the target micro BS 40 even if the radio wave condition demands more transmitted power. Therefore, it is desirable to be able to control availability in a stepwise manner depending on a situation such as when at most second-priority offset correction information should be available and when at most first-priority offset correction information should be available.

### Fourth Embodiment

A mobile terminal and a macro base station according to a fourth embodiment of the invention will now be described. In the first to third embodiments as described above, examples in which offset information and offset correction information common to all mobile terminals 10 and all micro BSs 40 have been described. In the fourth embodiment, however, the macro base station 30 transmits offset information common to all mobile tell finals 10 and also transmits offset correction information different for each micro BS 40 that reflects settings specific to each mobile terminal 10.

The basic configuration of the mobile terminal 10 and the macro base station 30 according to the fourth embodiment is similar to that of the mobile terminal 10 and the macro base station 30 according to the first embodiment. The mobile terminal 10 makes a request to change offset information directed to a micro BS 40 in response to a change in inclination settings of the user. The network side advertises offset information that the mobile terminal 10 uses to determine a level of ease of connection with the micro BS 40 through the macro base station 30. The network side notifies a list of offset correction information separately to each mobile terminal 10 through the macro base station 30 for correcting the offset information when the mobile terminal 10 determines a level of ease of connection with their respective micro BS 40.

When the mobile terminal 10 discovers a micro BS 40, the mobile terminal 10 uses a value obtained by correcting offset information received from the macro base station 30 with offset correction information corresponding to the discovered micro BS 40 to select a cell.

### Fifth Embodiment

A mobile terminal and a macro base station according to a fifth embodiment of the invention will now be described. In the first to third embodiments as described above, examples in which offset information and offset correction information common to all mobile terminals 10 and all micro BSs 40 have been described. In the fifth embodiment, however, the macro base station 30 transmits offset information different for each micro BS 40 with settings specific to each mobile terminal 10 reflected, and also transmits offset correction information common to all mobile terminals 10.

The basic configuration of the mobile terminal 10 and the macro base station 30 according to the fifth embodiment is similar to that of the mobile terminal 10 and the macro base station 30 according to the first embodiment. The network side advertises a list of IDs of micro BSs 40 corresponding to offset information used for determining a level of ease of connection with the respective micro BSs 40. The network side separately notifies offset correction information for correcting the offset information when each mobile terminal 10 determines a level of ease of connection with the micro BS 40 through the macro base station 30.

When the mobile terminal 10 discovers a micro BS 40, the mobile terminal 10 uses the offset information received from the macro base station 30 and the offset correction information corresponding to the discovered micro BS 40 to select a cell.

### Sixth Embodiment

A mobile terminal 10a according to a sixth embodiment of the invention will now be described. In the second embodiment as described above, an example of applying availability information to all mobile terminals 10a and all micro BSs 40 have been described. In the sixth embodiment, however, availability of offset information and offset correction information is set taking into consideration interference in each cell of the micro BSs 40 to define whether offset information and offset correction information can be applied or not for each micro BS 40.

A possible example of setting offset information and offset correction information is to refer to a value of information called “intra-frequency cell reselection indicator (IFRI)” advertised from a cell of a micro BS 40. The IFRI bit is information indicative of which cell is to be selected by a mobile terminal 10a when a micro BS 40 that has the highest reception quality for the mobile terminal 10a does not provide access permission for the mobile terminal 10a. For example, when a micro BS 40 that has the highest reception quality among detected cells does not provide access permission for the mobile terminal 10a, the mobile terminal 10a refers to the IFRI bit included in system information of the cell. The mobile terminal 10a checks the contents of IFRI bit in the availability checking section 26. If the IFRI bit indicates “allowed”, the mobile terminal 10a will perform cell selection for selecting another cell of the same frequency that has good reception quality without changing the currently used frequency. In this case, there arises a problem of uplink and downlink interference. Therefore, the increase of the uplink and downlink interference can be suppressed by prohibiting the use of offset information and offset correction information. On the other hand, if the IFRI bit indicates “non-allowed”, the mobile terminal 10a will change the currently used frequency to perform cell selection for selecting a cell of other frequencies. In this case, offset information and offset correction information are available because of less effects of interference. According to the embodiment, interference can be taken into consideration in offset control for each micro BS 40 in a more flexible manner.

The basic configuration of the mobile terminal 10a according to the sixth embodiment is similar to that of the mobile terminal 10a according to the second embodiment. The basic configuration of the macro base station according to the sixth embodiment is similar to that of the macro base station 30 according to the first embodiment. The micro BS 40 transmits the IFRI bit as system information.

Although the mobile terminal and the macro base station of the invention have been described above, the present invention is not limited to the embodiments as described above.

Different micro BSs 40 may be operated at different frequencies. In this case, there may be a possibility that cell selectability should be changed depending on whether a micro BS 40 to be selected is operated in the same frequency band as that of the base station to which the micro BS 40 is connected or in a different frequency band. In this case, control is facilitated by using offset correction information as information for changing priorities in the same or different frequency band. For example, offset information to be advertised is predefined as offset information for use in micro BSs 40 operated in the same frequency band, and in order to use the offset information in a micro BS 40 operated in a different frequency band, the offset information may first be corrected with offset correction information and the resultant corrected offset information can be used.

The offset correction information may be separated from offset correction information applied to a micro BS 40 selected based on user inclination settings as described above to be notified in a distinguishable manner and may implement correction independently from each other.

In this way, using offset correction information to control priorities in the same or different frequency band may facilitate priority control and may allow flexible response to micro BSs 40 that change their operating frequency depend on situations.

Offset correction information may have a different setting for each macro base station 30. For example, offset information may be different for each macro base station 30, or may be set to an appropriate value depending on micro BSs 40 in a cell provided by the macro base station 30 (because different cells have different micro BSs 40). Therefore, it is desirable that the mobile terminals 10 retain offset correction information as information element that needs to be reread (or received again) whenever the macro base station 30 is changed.

Different values of offset correction information may be advertised depending on time zones. Therefore, it is desirable that the mobile terminals 10 reread (or receive again) offset correction information after a certain time period even in the state where data is not transmitted between the mobile terminal 10 side and the network side (idle state).

In a case where the network side desires to change the amount of correction of offset correction information while maintaining an available state (in the state of availability information), it is desirable, for example, that the macro base station 30 is adapted to page (and the mobile terminal 10 is adapted to receive the paging) so as to change offset correction information at any timing and direct the mobile terminal 10 to receive again the updated value.

As described in the exemplary application in a university campus, the mobile terminal 10 may perform cell selection for transferring from the currently connected micro BS 40 to another micro BS 40, or the mobile terminal 10 may perform cell selection for transferring from the micro BS 40 to the macro base station 30. To accommodate these situations, the micro BS 40 may be adapted to transmit offset information and offset correction information different from those of the macro base station 30, and the mobile terminal 10 may be adapted to receive and store them as update or offset information and offset correction information received from the micro BS 40 for later use. In this way, it is possible to add other cell selection trends to cell selection between micro BSs 40, to reflect user inclination settings regarding a stay in a micro BS 40, and to perform addition of offset correction information from a micro BS 40 for distinguishing between the same frequency band and a different frequency band.

Advertisement and individual notification may use a group notification (multicast) performed in a group in which a plurality of mobile terminals 10 are collected.

In the first to third embodiments as described above, although examples in which offset information and offset correction information are broadcasted have been described, one or both of offset information and offset correction information may separately be notified by unicast.

In the embodiments as described above, although it is assumed that offset correction information is added to or subtracted from offset information to shift the value, information that is replaced with offset information itself may be notified. That is, a first offset information for use when a preferential connection is permitted and a second offset information for use when the preferential connection is not permitted may be notified. In a case where it is desirable to change the level of priority in a stepwise manner, multiple pieces of offset information may be transmitted, such as a first offset information, a second offset information, a third offset information, and so on. In this case, although the amount of notified information increases, the structure for changing offset information in a mobile terminal is simplified because offset to be applied itself is notified.

The mobile terminal may be composed of a plurality of communication devices. For example, a computing system such as a personal computer may be provided with an external or embedded 3GPP communication device module or non-3GPP communication device module. In such a wide variety of mobile terminals, the present invention has the same advantages.

Each functional block in the above description of embodiments of the invention is typically implemented in an LSI (Large Scale Integration), or an integrated circuit. The functional block may be implemented separately in one chip, or may be implemented in one chip so as to contain a part or all of the block. Although referred to as LSI herein, it may also be referred to as IC (Integrated Circuit), system LSI, super LSI, or ultra LSI, depending on the integration.

An approach for integrated circuits is not limited to an LSI, and the integrated circuit may be a special purpose or general purpose processor. A programmable FPGA (Field Programmable Gate Array) or a reconfigurable processor in which connections and configurations of circuit cells within an LSI can be reconfigured after the LSI is fabricated may be used.

Furthermore, as the semiconductor technology advances or another technology is derived from the semiconductor technology to bring about an alternative integrated circuit technology that replaces an LSI in the future, such a technology may off course be used to integrate the functional blocks. For example, bio technologies may be applied.

Although preferred embodiments of the present invention conceivable at this time have been described, it will be appreciated that various modifications may be made to the embodiments and the attached claims are intended to encompass all such modifications that fall within the scope and true spirit of the invention.

### INDUSTRIAL APPLICABILITY

As described above, the present invention has an advantage that it is possible to adjust the level of how easily the priority home base station is selected, and is useful for a mobile terminal, a macro base station, and the like that implement cell selection control in a network comprising a cell that covers a wide area and a plurality of cells present in the wide area.

### REFERENCE SIGNS LIST

10,10a MOBILE TERMINAL
12 BASIC COMMUNICATION FUNCTIONALITY
14 INCLINATION SETTING SECTION
16 MICRO BS MANAGEMENT SECTION
18 OFFSET INFORMATION CORRECTION PROCESSING SECTION
20 OFFSET CORRECTION INFORMATION RETAINING SECTION
22 OFFSET INFORMATION RETAINING SECTION
24 CELL SELECTION SECTION
26 AVAILABILITY CHECKING SECTION
30,30a MACRO BASE STATION
32 BASIC COMMUNICATION FUNCTIONALITY
34 OFFSET GENERATING SECTION
36 OFFSET CORRECTION INFORMATION GENERATING SECTION
38 AVAILABILITY INFORMATION GENERATING SECTION
40a-40c MICRO BS

1-14. (canceled)

15. A mobile terminal used in a network comprising a macro base station and a plurality of home base stations, the mobile terminal comprising:
a reception quality measurement section for measuring reception quality of a signal transmitted from the macro base station and the home base station;
an offset information receiving section for receiving offset information used for cell selection from the macro base station;
an offset correction information receiving section for receiving offset correction information for correcting the offset information, the offset correction information being broadcasted from the macro base station;
a priority base station information storing section for storing information on at least one priority home base station among the plurality of home base stations, the priority home base station being preferentially selected to establish a connection;
an offset information correction section for correcting the offset information with the offset correction information when the priority home base station is detected; and
a cell selection section for adding offset information received at the offset information receiving section or offset information corrected at the offset information correction section to the reception quality, and performing cell selection based on the reception quality with the added offset information.

16. The mobile terminal according to claim 15, further comprising an upper limit storing section that stores an upper limit of a number of the priority home base stations that can be set.

17. The mobile terminal according to claim 16, further comprising an upper limit receiving section for receiving data indicative of the upper limit from the macro base station,
wherein the upper limit data received at the upper limit receiving section is stored in the upper limit storing section.

18. The mobile terminal according to claim 15, further comprising a system information receiving section for receiving system information containing availability information indicative of whether or not the offset correction information can be used from the macro base station,
wherein, when the priority home base station is detected, the cell selection section determines whether the offset correction information can be used based on the availability information contained in the system information.

19. The mobile terminal according to claim 15, wherein the offset correction information receiving section receives a plurality of pieces of offset correction information each indicating a different level of ease of connection with the priority home base station.

20. The mobile terminal according to claim 15, the macro base station is an eNodeB as specified by 3GPP and the home base station is a Home eNodeB as specified by 3GPP.

21. A macro base station comprising a plurality of home base stations in a cell under control, the macro base station comprising:
an offset information transmitting section for transmitting offset information used for cell selection to a mobile terminal; and
an offset correction information transmitting section for transmitting offset correction information for correcting the offset information to the mobile terminal by broadcast.

22. The macro base station according to claim 21, further comprising an upper limit transmitting section for transmitting data indicative of an upper limit of a number of priority home base stations that can be set as the priority home base stations with which a user desires to preferentially establish a connection among the plurality of home base stations.

23. The macro base station according to claim 21, further comprising a system information transmitting section for transmitting system information containing availability information indicative of whether or not the offset correction information can be used to the mobile terminal.

24. The macro base station according to claim 21, wherein the offset correction information transmitting section transmits, to the mobile terminal, a plurality of pieces of offset correction information each indicating a different level of ease of connection with the priority home base station.

25. The macro base station according to claim 21, the home base station is a Home eNodeB as specified by 3GPP.

26. A system for controlling cell selection performed by a mobile terminal in a network comprising a macro base station and a plurality of home base stations, wherein the macro base station comprises:
an offset information transmitting section for transmitting offset information used for cell selection to a mobile terminal; and
an offset correction information transmitting section for transmitting offset correction information for correcting the offset information to the mobile terminal by broadcast,
wherein the mobile terminal comprises:
a reception quality measurement section for measuring reception quality of a signal transmitted from the macro base station and the home base station;
an offset information receiving section for receiving the offset information from the macro base station;
an offset correction information receiving section for receiving the offset correction information from the macro base station;
a priority base station information storing section for storing information on at least one priority home base station among the plurality of home base stations, the priority home base station being preferentially selected to establish a connection;
an offset information correction section for correcting the offset information with the offset correction information when the priority home base station is detected; and
a cell selection section for adding offset information received at the offset information receiving section or offset information corrected at the offset information correction section to the reception quality, and performing cell selection based on the reception quality with the added offset information.

27. A cell selection method for a mobile terminal used in a network comprising a macro base station and a plurality of home base stations, the method comprising:
receiving offset information used for cell selection from the macro base station;
receiving offset correction information for correcting the offset information, the offset correction information being broadcasted from the macro base station;
storing information on at least one priority home base station among the plurality of home base stations in a priority base station information storing section, the priority home base station being preferentially selected to establish a connection;
measuring reception quality of a signal transmitted from the macro base station and the home base station;
correcting the offset information with the offset correction information when the priority home base station is detected; and
adding offset information received from the macro base station or offset information corrected with the offset correction information to the reception quality, and performing cell selection based on the reception quality with the added offset information.

28. A method for controlling cell selection of a mobile terminal by a macro base station comprising a plurality of home base stations in a cell under control, the method comprising:
transmitting offset information used for cell selection to the mobile terminal; and
transmitting offset correction information for correcting the offset information to the mobile to al by broadcast.
